(19) United States
(12) Patent Application Publication
(10) Pub. No.: US 2026/0082004 A1
(43) Pub. Date: Mar. 19, 2026

(54) IMAGE READING APPARATUS AND IMAGE FORMING APPARATUS

(71) Applicant: CANON KABUSHIKI KAISHA, Tokyo (JP)

(72) Inventor: TAKAHIRO ONO, Ibaraki (JP)

(21) Appl. No.: 19/325,673

(22) Filed: Sep. 11, 2025

(30) Foreign Application Priority Data
Sep. 18, 2024 (JP) 2024-161252

(51) Int. Cl. H04N 1/00

(52) U.S. Cl. CPC H04N 1/00588; H04N 1/00554; H04N 1/00602

(57) ABSTRACT

An image reading apparatus includes a reading unit including a frame, a transparent glass plate, and an image sensor, and a conveyance unit including a plurality of conveyance rollers. The conveyance unit includes (i) a first abutment portion and (ii) a second abutment portion, and is configured such that the first abutment portion and the second abutment portion abut a first surface of the transparent glass plate in a state where the conveyance unit is closed. The frame includes a first support portion, a second support portion, a third support portion, and a fourth support portion.

### BACKGROUND

### Field of the Technology

The present disclosure relates to an image reading apparatus that reads image information from a sheet, and an image forming apparatus that forms an image on a recording material.

### Description of the Related Art

Japanese Patent Application Publication No. 2024-008606 describes an image reading apparatus that includes an image reading unit including a light-transmissive member used for document feeding-reading, and a conveyance unit (ADF) that can be opened and closed with respect to the image reading unit. In the configuration described in this document, in a case where the ADF is closed, abutting portions disposed in the ADF abut against both end portions of the light-transmissive member, so that the relative position between the image reading unit and the ADF is kept properly.

However, if the light-transmissive member is bent due to the load applied from the abutment portions (abutting portions) of the conveyance unit to the light-transmissive member in a state where the conveyance unit is closed, the image reading accuracy may deteriorate.

### SUMMARY

The present disclosure provides an image reading apparatus and an image forming apparatus that can reduce bending of a transparent glass plate.

An aspect of the present disclosure provides an image reading apparatus including a reading unit including a frame, a transparent glass plate supported by the frame, and an image sensor configured to read image information from a sheet through the transparent glass plate, and a conveyance unit including a plurality of conveyance rollers and configured to convey the sheet whose image information is to be read by the image sensor by using the plurality of conveyance rollers, the conveyance unit being configured to be opened and closed with respect to the reading unit, wherein the conveyance unit includes (i) a first abutment portion disposed on a first side with respect to a center of the transparent glass plate in a sheet width direction orthogonal to a sheet conveyance direction and (ii) a second abutment portion disposed on a second side opposite to the first side with respect to the center of the transparent glass plate in the sheet width direction, and is configured such that the first abutment portion and the second abutment portion abut a first surface of the transparent glass plate in a state where the conveyance unit is closed, and wherein the frame includes a first support portion disposed on the first side with respect to the first abutment portion in the sheet width direction and configured to support a second surface of the transparent glass plate opposite to the first surface, a second support portion disposed on the second side with respect to the second abutment portion in the sheet width direction and configured to support the second surface of the transparent glass plate, a third support portion disposed in a range from the first abutment portion to the second abutment portion in the sheet width direction and configured to support the second surface of the transparent glass plate, and a fourth support portion disposed in the range from the first abutment portion to the second abutment portion in the sheet width direction, and on the second side with respect to the third support portion, and configured to support the second surface of the transparent glass plate.

Another aspect of the present disclosure provides an image forming apparatus comprising: an image forming apparatus body, and an image reading apparatus, wherein the image forming apparatus body includes an image forming portion configured to perform an image forming operation that forms an image on a recording material, based on image information that is read by the image reading apparatus, wherein the image reading apparatus includes: a reading unit including a frame, a transparent glass plate supported by the frame, and an image sensor configured to read image information from a sheet through the transparent glass plate, and a conveyance unit including a plurality of conveyance rollers and configured to convey the sheet whose image information is to be read by the image sensor by using the plurality of conveyance rollers, the conveyance unit being configured to be opened and closed with respect to the reading unit, wherein the conveyance unit includes (i) a first abutment portion disposed on a first side with respect to a center of the transparent glass plate in a sheet width direction orthogonal to a sheet conveyance direction and (ii) a second abutment portion disposed on a second side opposite to the first side with respect to the center of the transparent glass plate in the sheet width direction, and is configured such that the first abutment portion and the second abutment portion abut a first surface of the transparent glass plate in a state where the conveyance unit is closed, and wherein the frame includes a first support portion disposed on the first side with respect to the first abutment portion in the sheet width direction and configured to support a second surface of the transparent glass plate opposite to the first surface, a second support portion disposed on the second side with respect to the second abutment portion in the sheet width direction and configured to support the second surface of the transparent glass plate, a third support portion disposed in a range from the first abutment portion to the second abutment portion in the sheet width direction and configured to support the second surface of the transparent glass plate, and a fourth support portion disposed in the range from the first abutment portion to the second abutment portion in the sheet width direction, and on the second side with respect to the third support portion, and configured to support the second surface of the transparent glass plate.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an image forming apparatus of a first embodiment.

FIG. 2 is a schematic diagram of an image reading apparatus of the first embodiment.

FIG. 3 is a perspective view of a reading unit of the first embodiment.

FIG. 4 is a perspective view illustrating the interior of the reading unit of the first embodiment.

FIG. 5 is a perspective view of an ADF of the first embodiment.

FIG. 6 is a cross-sectional view of the image reading apparatus of the first embodiment.

FIG. 7A is a diagram in which an upper frame and a document feeding-reading glass of the reading unit of the first embodiment are viewed from below.

FIG. 7B is a plan view illustrating a positional relationship between the document feeding-reading glass and other components of the first embodiment.

FIG. 8 is a perspective view illustrating a portion of the reading unit of the first embodiment.

FIG. 9A is a perspective view of a hinge portion of a second embodiment.

FIG. 9B is a side view of the hinge portion of the second embodiment.

FIG. 10 is an exploded view of the hinge portion of the second embodiment.

FIG. 11A is a diagram illustrating the hinge portion of the second embodiment.

FIG. 11B is a diagram illustrating the hinge portion of the second embodiment.

FIG. 11C is a diagram illustrating the hinge portion of the second embodiment.

### DESCRIPTION OF THE EMBODIMENTS

Hereinafter, some embodiments of the present disclosure will be described with reference to the accompanying drawings.

### First Embodiment

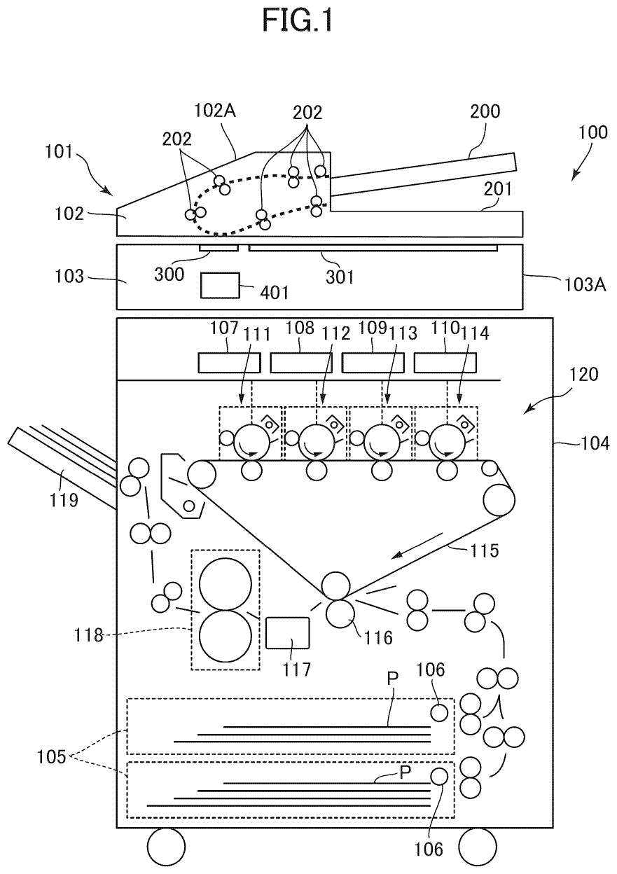

First, an image forming apparatus 100 and an image reading apparatus 101 of a first embodiment will be described with reference to FIGS. 1 to 3. The image forming apparatus 100 of the present embodiment is an electrophotographic color copying machine that includes an image forming portion 120 that serves as an image forming portion, and the image reading apparatus 101. The image forming apparatus 100 forms an image on a recording material (recording medium) P, based on image information that is read from a document by the image reading apparatus 101. Each of the recording material P and the document may be any one of a variety of sheets with different sizes and materials. For example, each of the recording material P and the document may be a paper sheet, such as a plain paper sheet or a thick paper sheet, a sheet material, such as a coated paper sheet, on which certain surface treatment has been performed, a specially-shaped sheet material, such as an envelope or an index paper sheet, a plastic film, or a cloth sheet.

Note that the color copying machine described in the present embodiment is merely one example. Thus, the image forming apparatus may be a facsimile or a multi-function printer. In addition, the image forming portion may not be the electrophotographic image forming portion. For example, the image forming portion may be an ink-jet printing mechanism.

As illustrated in FIG. 1, the image forming apparatus 100 includes a printer body 104 that serves as the apparatus body of the image forming apparatus, and the image reading apparatus 101 disposed above the printer body 104. The printer body 104 includes the image forming portion 120, a cassette 105, and a fixing apparatus 118. The image reading apparatus 101 includes a reading unit (reader portion) 103, and an automatic document feeder (ADF) 102 disposed above the reading unit 103 and serving as a conveyance unit.

The image forming portion 120 includes process units 111, 112, 113, and 114; laser scanners 107, 108, 109, and 110 that serve as exposing portions; an intermediate transfer belt 115 that serves as an intermediate transfer member; and a secondary transfer roller 116 that serves as a transfer portion. Each of the process units 111 to 114 includes a photosensitive drum that serves as an image bearing member, a charging portion, a developing portion, and a cleaning portion. Each of the charging portion, the developing portion, and the cleaning portion performs operation on the photosensitive drum, and thereby executes each process of the electrophotographic process.

### Image Forming Operation

The printer body 104 performs an image forming operation that is a series of operations for forming an image while conveying the recording material P one by one. If a user presses a copy execution button in a state where a document is set, for example, on the image reading apparatus 101, a control portion of the image forming apparatus 100 causes the image reading apparatus 101 to start a reading operation, and causes the printer body 104 to start an image forming operation.

If the image forming operation is started, the photosensitive drum of each of the process units 111 to 114 and the intermediate transfer belt 115 are driven and rotated. Each photosensitive drum is uniformly charged by the charging portion. Each of the laser scanners 107 to 110 is driven by a video signal produced based on the image information obtained by the image reading apparatus 101, and emits a laser beam to a corresponding photosensitive drum. With this operation, an electrostatic latent image is formed on the surface of each of the four photosensitive drums. The electrostatic latent image has a corresponding color component of yellow, magenta, cyan, or black. The electrostatic latent image is developed into a monochrome toner image, with the developer (toner) supplied from the developing portion to the photosensitive drum. The monochrome toner image formed on the surface of each of the photosensitive drums is transferred from the photosensitive drum onto the intermediate transfer belt 115 by a voltage being applied to a corresponding primary transfer roller. In this case, the monochrome toner image is transferred such that the four monochrome toner images are superposed on each other, so that a full-color image (hereinafter referred to simply as an image) is formed on the intermediate transfer belt 115.

In parallel with the above-described operation of the image forming portion 120, a recording material P stored in any one of the cassettes 105 is fed by a feeding roller 106. The recording material P is fed to a registration roller pair, and the skew of the recording material P is corrected by the registration roller pair. After that, the recording material P is conveyed to a secondary transfer portion formed between the intermediate transfer belt 115 and the secondary transfer roller 116. Then, an image is transferred from the intermediate transfer belt 115 to the recording material P by a voltage being applied to the secondary transfer roller 116.

The recording material P that has passed through the secondary transfer portion is conveyed to the fixing apparatus 118 through a pre-fixing conveyance portion 117. The fixing apparatus 118 fixes an image formed on the recording material P, to the recording material P by heating and pressing the image while nipping and conveying the recording material P in the nip portion of a fixing roller pair. The recording material P that has passed through the fixing apparatus 118 is discharged to the outside of the printer body 104 by a discharging unit, and is stacked on a discharging tray 119.

### Image Reading Apparatus

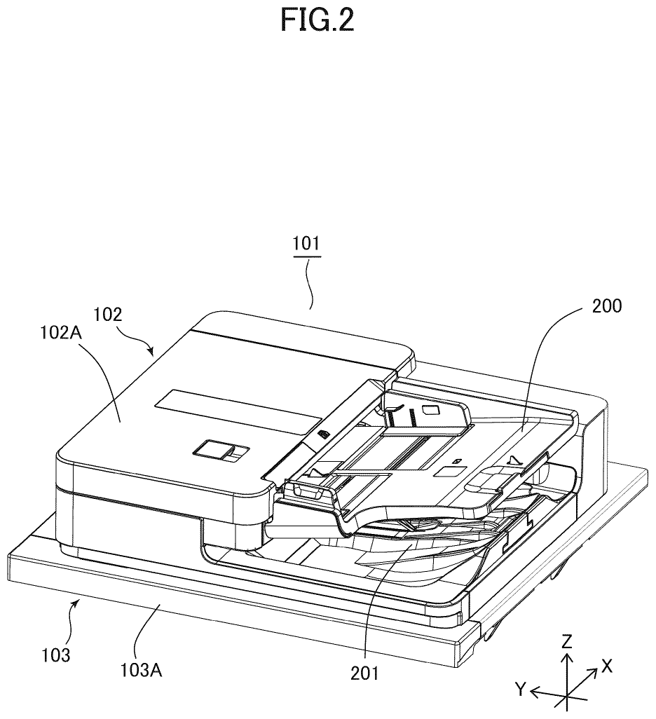

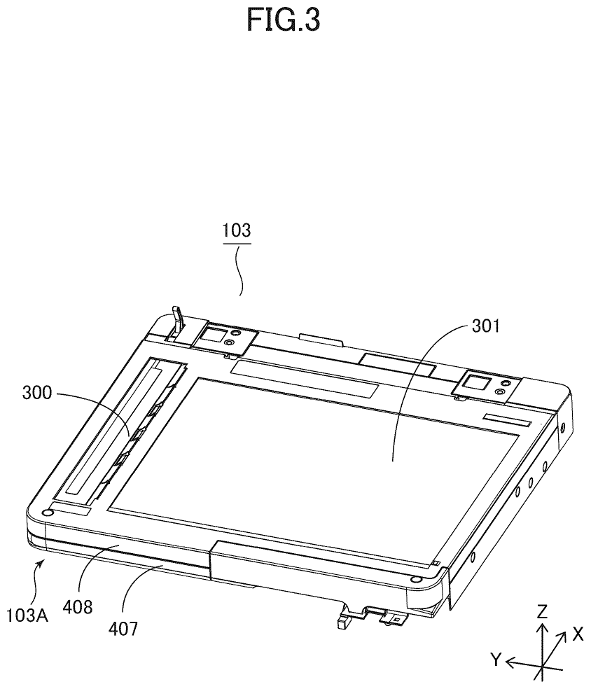

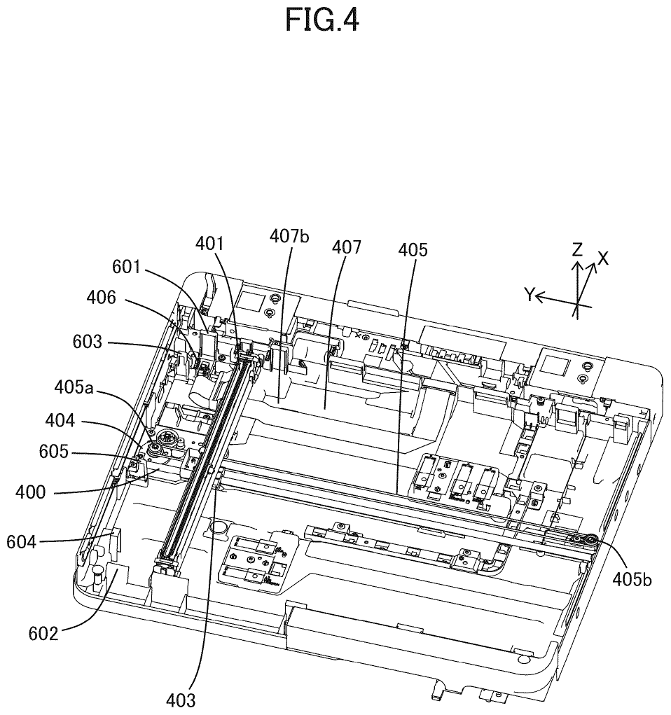

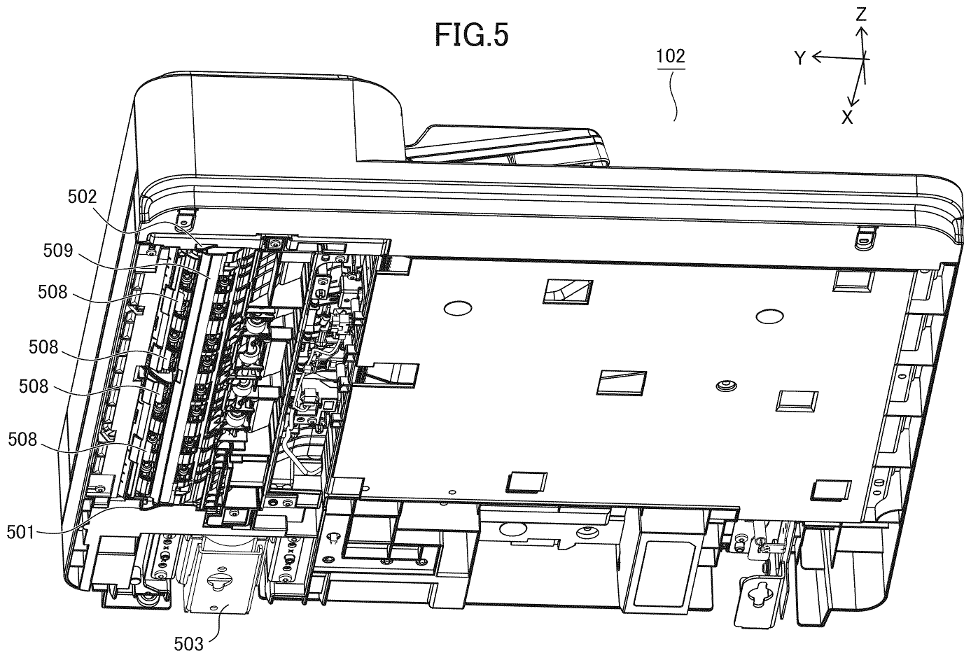

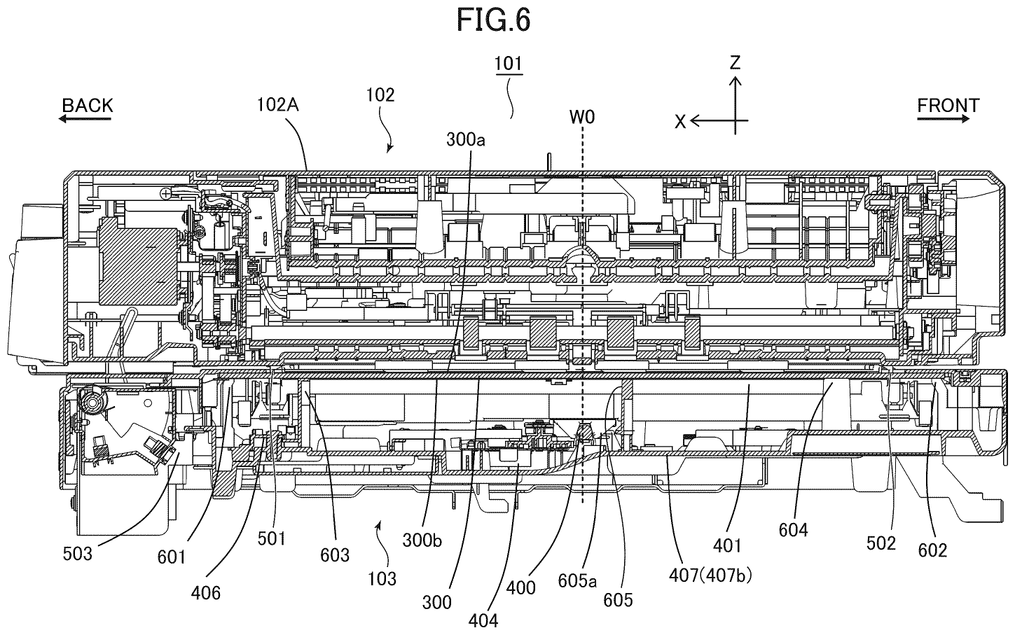

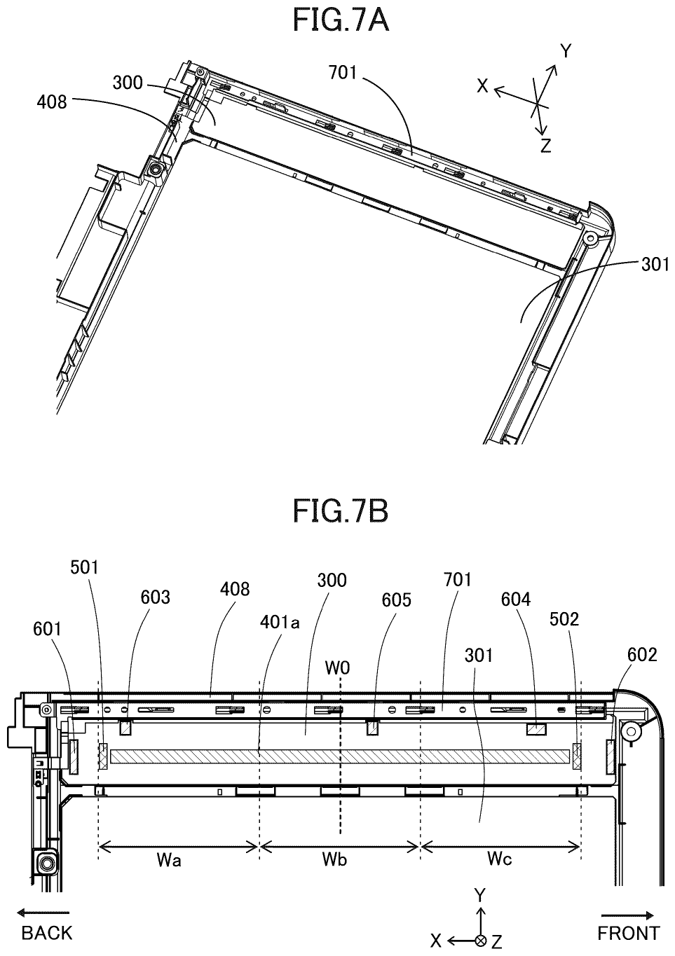

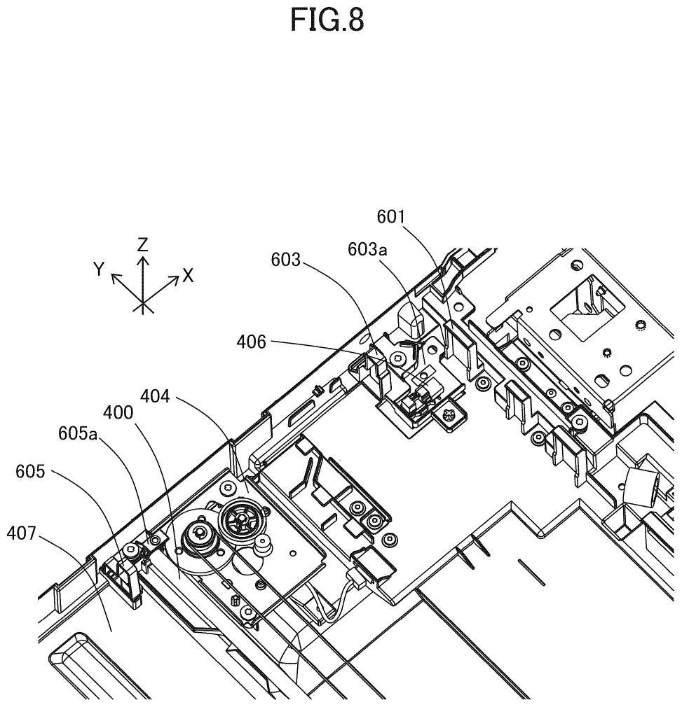

Next, the image reading apparatus 101 will be described. FIG. 2 is a perspective view of the image reading apparatus 101. FIG. 3 is a perspective view of the reading unit 103. FIG. 4 is a perspective view illustrating the interior of the reading unit 103. FIG. 5 is a perspective view in which the ADF 102 is viewed from below. FIG. 6 is a cross-sectional view of the image reading apparatus 101, taken along an imaginary plane that passes through a document feeding-reading glass 300. FIG. 7A is a perspective view in which an upper frame 408 and the document feeding-reading glass 300 of the reading unit 103 are viewed from below. FIG. 7B is a diagram in which the document feeding-reading glass 300 is viewed from below. FIG. 8 is a perspective view in which a portion of the interior of the reading unit 103 is enlarged.

In the following description and the figures, a sheet width direction orthogonal to a conveyance direction (sheet conveyance direction) of a document in the ADF 102 is defined as an X direction. In addition, a vertical direction in a case where the image forming apparatus 100 is placed on a horizontal plane is defined as a Z direction. In addition, a direction that intersects both of the X direction and the Z direction is defined as a Y direction. The X direction, the Y direction, and the Z direction can be orthogonal to each other. The X direction serves also as a main scanning direction of a scanning unit (reading portion) 401 included in the reading unit 103. In addition, one side (i.e., a direction opposite to an arrow X, or a direction that extends toward the lower left in FIG. 2) of the X direction may be referred to as a front direction or a front side, and a direction opposite to the one side may be referred to as a back direction or a back side.

### Reading Unit

As illustrated in FIGS. 1 and 3, the reading unit 103 includes a reader frame 103A, the document feeding-reading glass 300, a document platen glass 301, and the scanning unit 401.

Each of the document feeding-reading glass 300 and the document platen glass 301 is an example of a light-transmissive member (light transmitting member, transparent glass plate) that transmits light. The scanning unit 401 is an example of a reading portion that reads image information from a document. The scanning unit 401 converts an optical image obtained by optically scanning a document through the document feeding-reading glass 300 or the document platen glass 301, to an electrical signal by performing the photoelectric conversion. In the scanning unit (reading portion) 401, a contact image sensor (CIS) or charge-coupled device (CCD) sensor may be used.

The reading unit 103 can perform an operation (i.e., fixed-document reading) for reading image information from a stationary document that is set on the document platen glass 301. Specifically, the reading unit 103 performs the operation by moving the scanning unit 401 in the Y direction (i.e., a sub-scanning direction), in a space below the document platen glass 301. In addition, the reading unit 103 can perform an operation (i.e., document feeding-reading) for reading image information, through the document feeding-reading glass 300, from a document conveyed by the ADF 102. Specifically, the reading unit 103 performs the operation in a state where the reading unit 103 positions the scanning unit 401 at a position below the document feeding-reading glass 300.

The reader frame 103A includes a lower frame 407 (first frame), and the upper frame 408 (second frame). The lower frame 407 includes a bottom surface portion 407b whose shape is substantially rectangular when viewed from above, and surrounding walls which extend upward from the outer circumferential portion of the bottom surface portion 407b. The bottom surface portion 407b forms at least a portion of the bottom surface of the whole of the image reading apparatus 101. The upper frame 408 is a frame member that includes a top surface portion whose shape is substantially rectangular when viewed from above, surrounding walls which extend downward from the outer circumferential portion of the top surface portion, and opening portions formed in the top surface portion. The document feeding-reading glass 300 and the document platen glass 301 are attached to the upper frame 408. The upper frame 408 of the present embodiment includes a first opening portion to which the document feeding-reading glass 300 is attached, and a second opening portion to which the document platen glass 301 is attached.

The upper frame 408 is attached to the lower frame 407 so as to cover the lower frame 407 from above. The scanning unit 401 is accommodated in an internal space formed between the upper frame 408, to which the document feeding-reading glass 300 and the document platen glass 301 are attached, and the lower frame 407.

The lower frame 407 and the upper frame 408 of the present embodiment are made of resin material. That is, the reader frame 103A of the reading unit 103 is constituted not by metal frames, but by frame members (407, 408) made of resin. In addition, the upper frame 408 and the lower frame 407, together with the document feeding-reading glass 300 and the document platen glass 301, form a thin casing (structural frame) formed like a rectangular parallelepiped. However, in contrast to the above description, a portion of the reader frame 103A may be made of metal. For example, a portion of the upper frame 408 or the lower frame 407 may be made of metal material by performing the two-color molding.

As illustrated in FIG. 4, the reading unit 103 includes a plurality of components used for driving the scanning unit 401 and disposed in the internal space of the reader frame 103A. In the present embodiment, examples of the plurality of components disposed in the internal space of the reader frame 103A include a shaft 400, a shaft receiving member 403, a motor 404, a timing belt 405, and a home-position sensor 406.

The shaft 400 extends in the Y direction (i.e., the sub-scanning direction) that intersects the sheet width direction (i.e., the X direction), and is fixed to the lower frame 407. The shaft 400 is an example of a guide member that guides the movement of the scanning unit (reading portion) 401. The shaft receiving member 403 supports the scanning unit 401. In addition, the shaft receiving member 403 has a hole portion into which the shaft 400 is inserted, and can move along the shaft 400 in the Y direction. The shaft receiving member 403 is fixed to the timing belt 405. The timing belt 405 is stretched by and wound around pulleys 405a and 405b separated from each other in the Y direction, and is driven and rotated by the motor 404. The timing belt 405 is driven and rotated by the driving force of the motor 404, so that the scanning unit 401 moves back and forth along the shaft 400 in the Y direction. Note that in the present embodiment, the scanning unit 401 moves along the single shaft 400 disposed in a center portion in the sheet width direction.

The home-position sensor 406 is a sensor that can detect that the scanning unit 401 is positioned at a predetermined position in the Y direction. For example, the home-position sensor 406 may be an optical sensor. Thus, if the scanning unit 401 is located at a position (where the scanning unit 401 faces the document feeding-reading glass 300) at which the scanning unit 401 performs the document feeding-reading, the light to the optical sensor is blocked by a light blocking portion disposed in the scanning unit 401. In this case, the home-position sensor 406 includes a light emitting portion that emits light, a light receiving portion that receives the light emitted from the light emitting portion, and a sensor circuit that drives the light emitting portion and converts the change in state of the light receiving portion, to an electrical signal and outputs the electrical signal.

### ADF

As illustrated in FIGS. 1 and 2, the ADF 102 includes an ADF frame 102A, a document tray 200, a discharging tray 201, a plurality of conveyance units 202, and abutment portions (501, 502) that can abut against the document feeding-reading glass 300. Note that since FIG. 1 is a schematic diagram, the plurality of conveyance units 202 of the ADF 102 is not necessarily disposed as illustrated in FIG. 1.

The ADF frame 102A is supported by the reader frame 103A of the reading unit 103 via a hinge portion 503 (FIGS. 5 and 6) disposed at an end portion of the ADF 102 on the back side. The hinge portion 503 pivotally connects the reading unit 103 and the ADF 102. Note that although FIGS. 5 and 6 illustrate the single hinge portion 503, the ADF 102 may be supported by two or more hinge portions 503 disposed adjacent to each other in the Y direction.

The ADF 102 pivots around an axis extending in the Y direction, with respect to the reading unit 103 via the hinge portion 503, so that the ADF 102 can be opened and closed with respect to the reading unit 103. In the present embodiment, a position at which the abutment portions (501, 502) abut against the document feeding-reading glass 300 of the reading unit 103 is referred to as a closed position of the ADF 102. In contrast, a position to which the abutment portions (501, 502) are pivoted so as to be separated from the document feeding-reading glass 300 is referred to as an open position of the ADF 102.

The document tray 200 and the discharging tray 201 are supported by the ADF frame 102A, or are formed integrally with a frame member that constitutes the ADF frame 102A. The frame member that constitutes the ADF frame 102A may be made of resin.

The plurality of conveyance units 202 is disposed along a conveyance path that is curved like a U shape, and that extends toward the discharging tray 201 through the interior of the ADF frame 102A. Examples of the plurality of conveyance units 202 may include a pickup roller that sends a document from the document tray 200, a separation roller pair that conveys the document sent by the pickup roller while separating the document, one by one, from other documents, and a read roller pair disposed upstream of the document feeding-reading glass 300 such that the rollers of the read roller pair are adjacent to each other. In addition, examples of the plurality of conveyance units 202 may include a discharging roller pair that discharges a document that has passed through the document feeding-reading glass 300, to the discharging tray 201.

As illustrated in FIG. 5, in the bottom surface of the ADF 102, guide pieces 508 and a platen guide 509 are disposed at positions that face the document feeding-reading glass 300. The platen guide 509 is a white board that is disposed at a position at which the platen guide 509 faces the scanning unit 401 in the document feeding-reading operation, and that serves as a background in a case where the scanning unit 401 reads image information from a document. In a state where the ADF 102 is closed, a conveyance path of documents is formed between the document feeding-reading glass 300 and the platen guide 509. Each of the guide pieces 508 is a plastic film piece that guides a document that has been conveyed to the guide piece through the interior of the ADF 102, toward the conveyance path formed between the document feeding-reading glass 300 and the platen guide 509. The guide pieces 508 are in contact with the document feeding-reading glass 300 in a state where the ADF 102 is closed.

### Abutment Portion

As illustrated in FIG. 5, the ADF (conveyance unit) 102 includes a first abutment portion (first abutting portion) 501 and a second abutment portion (second abutting portion) 502. Each of the first abutment portion 501 and the second abutment portion 502 projects downward from the bottom surface of the ADF frame 102A. As illustrated in FIGS. 6 and 7B, the first abutment portion 501 is disposed on one side (i.e., the back side or a first side) with respect to a center W0 of the document feeding-reading glass 300 in the sheet width direction (i.e., the X direction). The second abutment portion 502 is disposed on the other side (i.e., the front side or a second side) with respect to the center W0 of the document feeding-reading glass 300 in the sheet width direction.

In the present embodiment, the first abutment portion 501 is disposed on one side (i.e., the back side) with respect to a reading area 401a of the scanning unit 401 in the X direction, and the second abutment portion 502 is disposed on the other side (i.e., the front side) with respect to the reading area 401a of the scanning unit 401 in the X direction. The reading area 401a is a range in the X direction in which range the scanning unit (reading portion) 401 can obtain image information by optically scanning a document. In addition, the first abutment portion 501 is disposed on one side (i.e., the back side) with respect to a document passage area in the X direction, and the second abutment portion 502 is disposed on the other side (i.e., the front side) with respect to the document passage area in the X direction. The document passage area is an area in the X direction that a maximum-size document passes. The maximum-size document has the maximum size in the X direction (i.e., the sheet width direction) in the documents that can be conveyed by the ADF 102.

In a state where the ADF 102 is closed, the first abutment portion 501 and the second abutment portion 502 abut against a top surface 300a (i.e., a surface that contacts a document) of the document feeding-reading glass 300 that serves as a first surface (FIG. 6). With this operation, the ADF 102 is positioned with respect to the top surface 300a of the document feeding-reading glass 300. In addition, in a state where the ADF 102 is closed, a conveyance path through which a document passes is formed between the top surface 300a of the document feeding-reading glass 300 and the ADF 102. Since the ADF 102 is positioned, the conveyance path is formed with high accuracy, and the position that the document passes and that is positioned with respect to the document feeding-reading glass 300 becomes stable. As a result, the image reading accuracy of the reading unit 103 can be improved.

More specifically, the above-described document feeding-reading operation is performed in a state where the ADF 102 is closed. In a state where the ADF 102 is closed, the first abutment portion 501 and the second abutment portion 502, which are both disposed outside the platen guide 509 (exposed from the bottom surface of the ADF 102) (FIG. 5) in the sheet width direction, are abutted against the document feeding-reading glass 300. With this operation, the conveyance path is formed with high accuracy, between the top surface 300a of the document feeding-reading glass 300 and the platen guide 509.

### Document Feeding-Reading Glass

In the present embodiment, the document feeding-reading glass 300 is a glass having a thickness of 2.5 to 3.5 mm, for example. The type of the glass is not limited to a specific type, and the glass may be a float glass (a transparent flat glass, an ordinary glass) or a chemically strengthened glass. In addition, the document feeding-reading glass (light-transmissive member) 300 is not limited to a glass whose main component is silicate. That is, the document feeding-reading glass 300 has only to be a glass that has translucency suitable for reading image information from documents.

By the way, in a state where the ADF 102 is closed, the document feeding-reading glass 300 may be bent due to the pressing force that the document feeding-reading glass 300 receives from the first abutment portion 501 and the second abutment portion 502. If the document feeding-reading glass 300 is bent, the position that the document passes and that is positioned in the thickness direction of the document may change (the thickness direction is the direction of the depth of field of the optical system of the scanning unit 401 that guides the light reflected from the document, to the light receiving element). As a result, the image reading accuracy may deteriorate. If the thickness of the document feeding-reading glass 300 is decreased, the weight and cost of the document feeding-reading glass 300 can be reduced. In this case, however, since the stiffness of the document feeding-reading glass 300 decreases, the document feeding-reading glass 300 will bend easily.

Thus, in the present embodiment, a support structure that can reduce the bending of the document feeding-reading glass 300 will be proposed.

### Support Structure for Document Feeding-Reading Glass

The support structure for the document feeding-reading glass 300 of the reading unit 103 will be described. As illustrated in FIG. 6, the reading unit 103 includes support portions (601 to 605) that support a bottom surface 300b of the document feeding-reading glass 300, which serves as a second surface. The reading unit 103 of the present embodiment includes five support portions: a first support portion 601, a second support portion 602, a third support portion 603, a fourth support portion 604, and a fifth support portion 605.

The support portions 601 to 605 are disposed in the reader frame (frame) 103A. In the present embodiment, each of the support portions 601 to 605 is supported by the bottom surface portion 407b (see also FIG. 4) of the lower frame 407 (i.e., the first frame) of the reader frame 103A. Each of the support portions 601 to 605 is integrally formed with the bottom surface portion 407b, as a portion of the lower frame 407, or is a member separate from the lower frame 407 and fixed to the lower frame 407. Each of the support portions 601 to 605 has a shape that extends upward from the bottom surface portion 407b.

In the present embodiment, at least one of the first support portion 601, the second support portion 602, the third support portion 603, and the fourth support portion 604 is formed integrally with the lower frame 407 (i.e., the first frame). As a result, the number of components of the image reading apparatus 101 can be decreased. In addition, in the present embodiment, at least one of the first support portion 601, the second support portion 602, the third support portion 603, and the fourth support portion 604 is a member separate from the lower frame 407 (i.e., the first frame). More specifically, in an example of the present embodiment illustrated in FIG. 6, the first support portion 601, the second support portion 602, and the fourth support portion 604 are formed integrally with the lower frame 407, as a portion of the lower frame 407, and the third support portion 603 and the fifth support portion 605 are members separate from the lower frame 407 and fixed to the lower frame 407.

Note that each of the support portions 601 to 605 may be formed integrally with the lower frame 407, as a portion of the lower frame 407, or may be a member separate from the lower frame 407, as appropriate. For example, all the support portions 601 to 605 may be formed integrally with the lower frame 407, as a portion of the lower frame 407.

The document feeding-reading glass 300 is a member formed like a thin plate and elongated in the sheet width direction (i.e., the X direction). As illustrated in FIGS. 6 and 7B, the five support portions 601 to 605 are disposed at positions different from each other in the sheet width direction. The position of each of the support portions 601 to 605 is the position of a contact portion of the support portion that contacts the bottom surface 300b of the document feeding-reading glass 300.

The first support portion 601 is disposed at an end portion on one end side (i.e., the back side) of the document feeding-reading glass 300 in the sheet width direction. The second support portion 602 is disposed at an end portion on the other end side (i.e., the front side) of the document feeding-reading glass 300 in the sheet width direction.

The first abutment portion 501 and the second abutment portion 502 of the ADF 102, which abut against the document feeding-reading glass 300, are positioned between the first support portion 601 and the second support portion 602 in the sheet width direction. That is, the first support portion 601 is disposed on the back side (i.e., the first side) with respect to the first abutment portion 501 in the sheet width direction. The second support portion 602 is disposed on the front side (i.e., the second side opposite to the first side) with respect to the second abutment portion 502 in the sheet width direction. The first support portion 601 and the second support portion 602 support (hold) the bottom surface 300b of the document feeding-reading glass 300 at positions outside the first abutment portion 501 and the second abutment portion 502 in the longitudinal direction of the document feeding-reading glass 300 (i.e., the sheet width direction).

The third support portion 603 is disposed in a range from the first abutment portion 501 to the second abutment portion 502 in the sheet width direction. The fourth support portion 604 is disposed in the range from the first abutment portion 501 to the second abutment portion 502 in the sheet width direction, and on the front side (i.e., the second side) with respect to the third support portion 603.

The range from the first abutment portion 501 to the second abutment portion 502 in the sheet width direction includes the contact portion of the first abutment portion 501 and the contact portion of the second abutment portion 502 that contact the document feeding-reading glass 300. Thus, the third support portion 603 may be disposed such that at least a portion of an area in which the third support portion 603 and the document feeding-reading glass 300 contact each other in the sheet width direction overlaps with an area in which the first abutment portion 501 and the document feeding-reading glass 300 contact each other in the sheet width direction. Similarly, the fourth support portion 604 may be disposed such that at least a portion of an area in which the fourth support portion 604 and the document feeding-reading glass 300 contact each other in the sheet width direction overlaps with an area in which the second abutment portion 502 and the document feeding-reading glass 300 contact each other in the sheet width direction.

In the present embodiment, since the first support portion 601, the second support portion 602, the third support portion 603, and the fourth support portion 604 support the bottom surface 300b (i.e., the second surface) of the document feeding-reading glass 300, the bending of the document feeding-reading glass 300 caused by the load from the ADF 102 can be reduced.

That is, in a case where the ADF 102 is closed, the load is applied downward, due to the self weight of the ADF 102, from the first abutment portion 501 and the second abutment portion 502 to the document feeding-reading glass 300. If the document feeding-reading glass 300 is supported by only the first support portion 601 and the second support portion 602 disposed outside the first abutment portion 501 and the second abutment portion 502, the document feeding-reading glass 300 may bend such that a center portion of the document feeding-reading glass 300 moves down relative to both end portions of the document feeding-reading glass 300. In addition, if the document feeding-reading glass 300 is supported by only support portions disposed inside the first abutment portion 501 and the second abutment portion 502, the document feeding-reading glass 300 may bend such that a center portion of the document feeding-reading glass 300 moves up relative to both end portions of the document feeding-reading glass 300. In the present embodiment, however, the bending of the document feeding-reading glass 300 in which the center portion of the document feeding-reading glass 300 moves down can be reduced mainly by the third support portion 603 and the fourth support portion 604. In addition, in the present embodiment, the bending of the document feeding-reading glass 300 in which the center portion of the document feeding-reading glass 300 moves up can be reduced mainly by the first support portion 601 and the second support portion 602.

The heights of the top surfaces (i.e., contact surfaces that contact the document feeding-reading glass 300) of the support portions 601 to 605 in the thickness direction of the document feeding-reading glass 300 (i.e., the Z direction) can be equal to each other.

In the present embodiment, the third support portion 603 is disposed on the front side (i.e., the second side) with respect to the first abutment portion 501. In addition, in the present embodiment, the fourth support portion 604 is disposed on the back side (i.e., the first side) with respect to the second abutment portion 502. That is, the third support portion 603 and the fourth support portion 604 support (hold) the bottom surface 300b of the document feeding-reading glass 300 at positions inside the first abutment portion 501 and the second abutment portion 502 in the longitudinal direction of the document feeding-reading glass 300 (i.e., the sheet width direction).

The third support portion 603 may be disposed in the vicinity of the first abutment portion 501 in the sheet width direction, and the fourth support portion 604 may be disposed in the vicinity of the second abutment portion 502 in the sheet width direction. In the present embodiment, the third support portion 603 is disposed in an area Wa that is an area on the first abutment portion 501 side (i.e., the back side or the first side), of areas obtained by trisecting the range from the first abutment portion 501 to the second abutment portion 502 in the sheet width direction. In addition, in the present embodiment, the fourth support portion 604 is disposed in an area Wc that is an area on the second abutment portion 502 side (i.e., the front side or the second side), of the areas obtained by trisecting the range from the first abutment portion 501 to the second abutment portion 502 in the sheet width direction.

If the positional relationship between the third support portion 603 and the first abutment portion 501 does not hinder the movement of the scanning unit 401, at least a portion of the third support portion 603 may overlap with the first abutment portion 501 when viewed in the thickness direction of the document feeding-reading glass 300 (i.e., the Z direction in the present embodiment). In addition, at least a portion of the fourth support portion 604 may overlap with the second abutment portion 502 when viewed in the thickness direction of the document feeding-reading glass 300.

Note that the scanning unit 401 includes, in addition to a sensor board on which the light receiving element (photoelectric conversion element) is disposed, a light source, a light guiding member, a lens array or a mirror, and a casing that accommodates these components. The lens array constitutes an equal-magnification optical system, and the mirror constitutes a reduction optical system. The third support portion 603 and the fourth support portion 604 of the present embodiment are disposed so as not to interfere with the scanning unit 401 positioned at a position at which the scanning unit 401 performs the document feeding-reading.

The fifth support portion 605 is disposed between the third support portion 603 and the fourth support portion 604 in the sheet width direction. That is, the fifth support portion 605 is disposed on the front side with respect to the third support portion 603 in the sheet width direction, and on the back side with respect to the fourth support portion 604 in the sheet width direction. The fifth support portion 605 supports (holds) the bottom surface 300b of the document feeding-reading glass 300 at a position more inside than the third support portion 603 and the fourth support portion 604 in the longitudinal direction of the document feeding-reading glass 300 (i.e., the sheet width direction).

Since the fifth support portion 605 is disposed, the bending of the document feeding-reading glass 300 in which the center portion of the document feeding-reading glass 300 moves down can be further reduced. Even in a case where the fifth support portion 605 is not disposed, the bending of the document feeding-reading glass 300 in which the center portion of the document feeding-reading glass 300 moves down can be reduced mainly by the third support portion 603 and the fourth support portion 604. However, if the fifth support portion 605 is disposed, the bending of the document feeding-reading glass 300 in which the center portion of the document feeding-reading glass 300 moves down can be reduced even in a case where the third support portion 603 and/or the fourth support portion 604 is lower in height than the first support portion 601 and the second support portion 602 due to the dimensional tolerance of components or the like.

The fifth support portion 605 can be disposed in the vicinity of a center between the first abutment portion 501 and the second abutment portion 502 in the sheet width direction. For example, the fifth support portion 605 can be disposed in an area Wb that is the center area of the areas obtained by trisecting the range from the first abutment portion 501 to the second abutment portion 502 in the sheet width direction. With this arrangement, the bending of the document feeding-reading glass 300 can be further reduced. Note that in the present embodiment, the center between the first abutment portion 501 and the second abutment portion 502 is substantially equal to the center W0 of the document feeding-reading glass 300 and the center of the reading area 401a in the sheet width direction.

The above-described shaft 400 is disposed in the vicinity of the center between the first abutment portion 501 and the second abutment portion 502 in the sheet width direction (that is, in the vicinity of the center of the document feeding-reading glass 300 or in the vicinity of the center of the reading area 401a). Since the shaft 400 is disposed in the center in the sheet width direction, it becomes possible for the scanning unit 401 to hardly incline when moved along the shaft 400.

The shaft 400 extends substantially over the total length of the reader frame 103A in the sub-scanning direction (i.e., the Y direction), and the fifth support portion 605 is positioned at a position different from the position of the shaft 400 in the sheet width direction. The fifth support portion 605 of the present embodiment is disposed on the front side of the shaft 400 (that is, between the shaft 400 and the fourth support portion 604 in the sheet width direction). In addition, in the present embodiment, the motor 404 is disposed on the back side of the shaft 400 (that is, between the shaft 400 and the third support portion 603 in the sheet width direction).

As illustrated in FIG. 7B, the first support portion 601 and the second support portion 602 are disposed at positions at which the first support portion 601 and the second support portion 602 overlap with the reading area 401a in the sub-scanning direction of the scanning unit 401 (i.e., the Y direction). In other words, the positions of the first support portion 601 and the second support portion 602 in the moving direction (i.e., the downward direction in FIG. 7B) of a document conveyed along the document feeding-reading glass 300 at least partially overlap with the position of the reading area 401a in the moving direction of the document.

The first support portion 601 and the second support portion 602 are disposed outside the reading area 401a in the sheet width direction (i.e., the X direction). In addition, the first support portion 601 and the second support portion 602 are disposed so as to overlap with the reading area 401a in the sub-scanning direction (i.e., the Y direction). As a result, the document feeding-reading glass 300 can be held more stably at the reading position for the document feeding-reading. Note that the first abutment portion 501 and the second abutment portion 502 are also disposed so as to overlap with the reading area 401a in the sub-scanning direction of the scanning unit 401. As a result, the conveyance path can be formed with high accuracy at the reading position, so that the image reading accuracy can be improved.

On the other hand, the third support portion 603, the fourth support portion 604, and the fifth support portion 605 are disposed inside the reading area 401a in the sheet width direction (i.e., the X direction). In addition, the third support portion 603, the fourth support portion 604, and the fifth support portion 605 are disposed outside the reading area 401a in the sub-scanning direction of the scanning unit 401 (i.e., the Y direction). Thus, the third support portion 603, the fourth support portion 604, and the fifth support portion 605 can be disposed without hindering the movement of the scanning unit 401. The third support portion 603, the fourth support portion 604, and the fifth support portion 605 of the present embodiment are disposed opposite to the document platen glass 301 with respect to the reading area 401a of the scanning unit 401, in which the document feeding-reading is performed, in the sub-scanning direction of the scanning unit 401.

Reinforcement Member As illustrated in FIG. 7A, a reinforcement member 701 is attached to the upper frame 408 for reinforcing the document feeding-reading glass 300. The reinforcement member 701 is made of metal; and extends over a range that includes the reading area 401a of the scanning unit 401, in the sheet width direction (i.e., the longitudinal direction of the document feeding-reading glass 300). The reinforcement member 701 of the present embodiment is a metal plate member that extends substantially over the total length of the document feeding-reading glass 300 in the sheet width direction.

One of the long sides of the document feeding-reading glass 300 (i.e., one edge portion of the document feeding-reading glass 300 in the sub-scanning direction) is sandwiched between the upper frame 408 and the reinforcement member 701 in the thickness direction of the document feeding-reading glass 300 (i.e., the Z direction). That is, at least a portion of the one edge portion of the document feeding-reading glass (light-transmissive member) 300, which extends in the sheet width direction, is sandwiched between the upper frame (second frame) 408 and the reinforcement member 701 in the thickness direction of the document feeding-reading glass 300.

The reinforcement member 701 can prevent the document feeding-reading glass 300 from bending such that the center portion of the document feeding-reading glass 300 in the sheet width direction moves up relative to both end portions of the document feeding-reading glass 300. For example, there may be a case where the first support portion 601 and the second support portion 602 are lower in height than the third support portion 603 and the fourth support portion 604 due to the dimensional tolerance of components or the like. In this case, in a state where the ADF 102 is closed, the load caused by the self weight of the ADF 102 is applied downward from the first abutment portion 501 and the second abutment portion 502, positioned outside the third support portion 603 and the fourth support portion 604, to the document feeding-reading glass 300. However, since the document feeding-reading glass 300 is reinforced by the reinforcement member 701, the document feeding-reading glass 300 can be prevented from bending such that the center portion of the document feeding-reading glass 300 moves up relative to both end portions of the document feeding-reading glass 300. In addition, since the reinforcement member 701 is made of a metal plate, the amount of bending can be made smaller than that in a case where the bending of the document feeding-reading glass 300 is restricted by only the upper frame 408 made of resin.

### Detailed Description of Third Support Member and Fifth Support Member

Next, the third support portion 603 and the fifth support portion 605 that are members separate from the lower frame 407 will be further described.

As illustrated in FIG. 8, the third support portion 603 has a function that causes the third support portion 603 to serve as a holding portion that holds the home-position sensor 406. That is, the third support portion 603 is formed integrally with a sensor holding portion 603a to which the home-position sensor 406 is attached. The home-position sensor 406 is attached to the sensor holding portion 603a, and the integrally-formed component that includes the sensor holding portion 603a and the third support portion 603 is attached to the lower frame 407. In this manner, the home-position sensor 406 is fixed to the reader frame 103A. With this configuration, the number of components of the image reading apparatus 101, the cost of components, and the man-hours of assembly can be decreased, compared with a case where the third support portion 603 and the sensor holding portion 603a are separate members.

In addition, the fifth support portion 605 has a function that causes the fifth support portion 605 to serve as a fixing portion that fixes the shaft 400 to the lower frame 407. That is, the fifth support portion 605 is formed integrally with a shaft fixing portion 605a that fixes the shaft 400. The integrally-formed component that includes the shaft fixing portion 605a and the fifth support portion 605 is attached to the lower frame 407, so that the shaft 400 is positioned by the shaft fixing portion 605a. With this configuration, the number of components of the image reading apparatus 101, the cost of components, and the man-hours of assembly can be decreased, compared with a case where the fifth support portion 605 and the shaft fixing portion 605a are separate members.

Note that in the present embodiment, the description has been made for the case where the third support portion 603 and the sensor holding portion 603a for the home-position sensor 406 are integrally formed with each other. However, the sensor holding portion 603a may hold another sensor. In addition, in the present embodiment, the description has been made, as an example, for the case where the fifth support portion 605 and the shaft fixing portion 605a are formed integrally with each other. However, the fixing portion formed integrally with the fifth support portion 605 may fix (position) a component other than the shaft 400. In addition, another support portion 601, 602, or 604 other than the third support portion 603 and the fifth support portion 605 may be formed integrally with a portion that functions, like the sensor holding portion 603a and the shaft fixing portion 605a, to hold (fix or position) another component.

### Second Embodiment

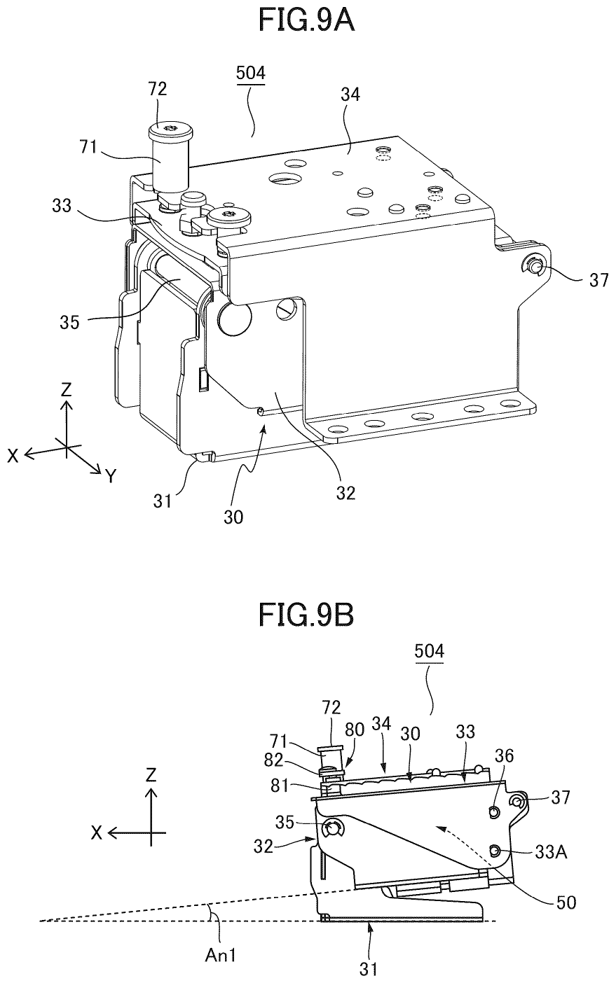

Next, a second embodiment of the present disclosure will be described with reference to FIGS. 9A and 9B, FIG. 10, and FIGS. 11A to 11C. In the present embodiment, a hinge portion 504 that has a function to stabilize the posture of the ADF 102 will be described in detail, and the relationship between the urging force of the hinge portion 504 and the configuration for supporting the document feeding-reading glass 300 will be described.

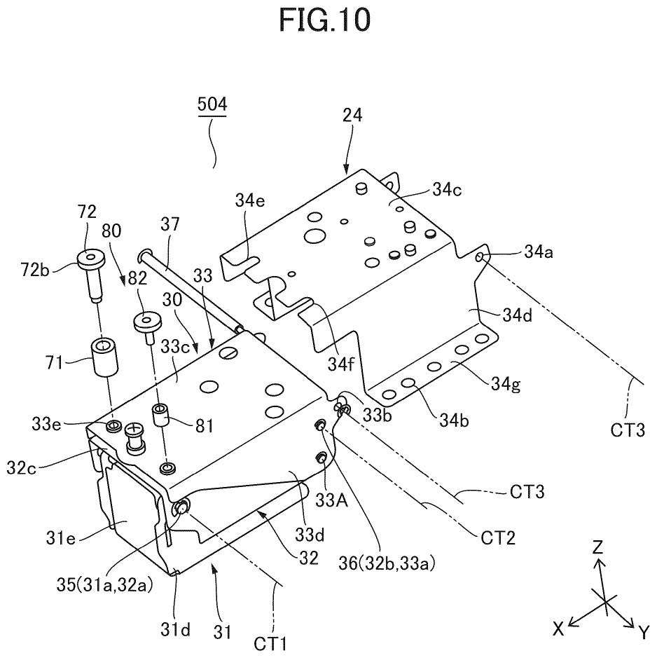

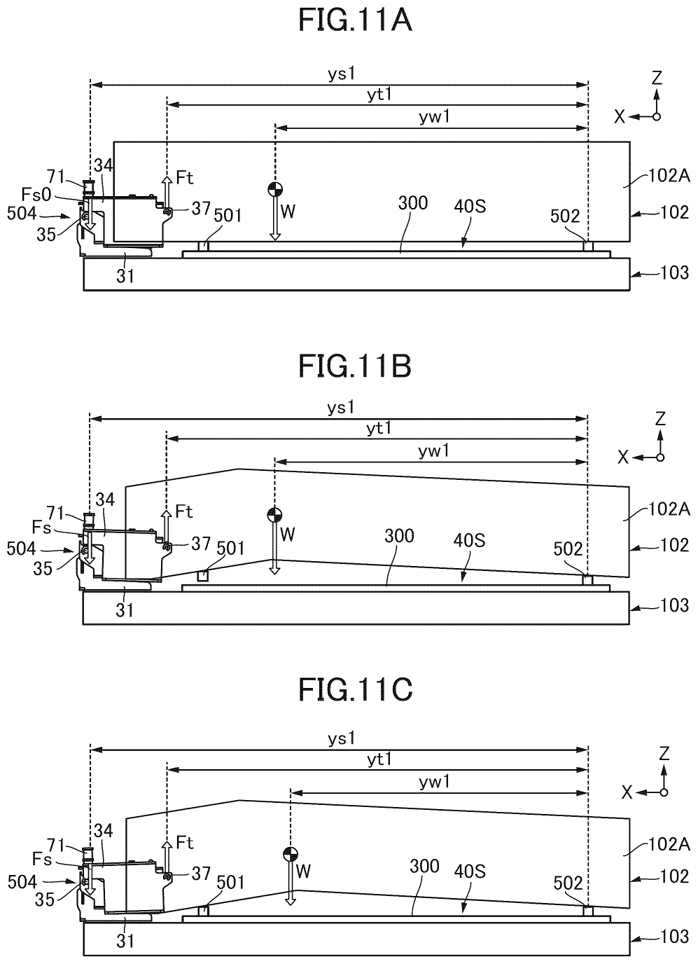

FIG. 9A is a perspective view illustrating the hinge portion 504. FIG. 9B is a side view in which the hinge portion 504 is viewed in the Y direction. FIG. 10 is an exploded view of the hinge portion 504. Each of FIGS. 11A to 11C is a schematic diagram in which the image reading apparatus 101 is viewed in the Y direction, and which illustrates the function of the hinge portion 504. Note that for describing the configuration of the hinge portion 504, a front-and-back direction (i.e., the X direction) of the image reading apparatus 101, a right-and-left direction (i.e., the Y direction), and a vertical direction (i.e., the Z direction) are defined, for convenience of description, in a state where the image reading apparatus 101 is fixed to the image forming apparatus 100.

As illustrated in FIGS. 9A, 9B, and 10, the hinge portion 504 includes a fixing member 31, a first pivot member 32, a second pivot member 33, and a third pivot member 34. In addition, the hinge portion 504 includes a hinge pivot shaft 35, a lift shaft 33A, a book pivot shaft 36, an equalizing shaft 37, an equalizing spring 71, and a torque applying portion 50.

The fixing member 31 is fixed to the reader frame 103A. The first pivot member 32 is supported by the fixing member 31 via the hinge pivot shaft 35, and can pivot with respect to the fixing member 31. The book pivot shaft 36 is held by the first pivot member 32. The second pivot member 33 is supported by the first pivot member 32 via the book pivot shaft 36, and can pivot with respect to the first pivot member 32. The lift shaft 33A and the equalizing shaft 37 are held by the second pivot member 33. The third pivot member 34 is supported by the second pivot member 33 via the equalizing shaft 37, and can pivot with respect to the second pivot member 33. In addition, the third pivot member 34 is fixed to the ADF frame 102A, and moves together with the ADF 102.

The equalizing spring 71 is an example of an urging member that applies downward force to the ADF 102 in a state where the ADF (conveyance unit) 102 is closed. The fixing member 31 is an example of a first member fixed to the frame of the reading unit. The hinge pivot shaft 35 is an example of a first shaft supported by the first member. A module constituted by the lift shaft 33A, the first pivot member 32, the second pivot member 33, and the book pivot shaft 36 is an example of a pivot unit that pivots around the first shaft, with respect to the first member. The equalizing shaft 37 is an example of a second shaft supported by the pivot unit. The third pivot member 34 is an example of a second member that is fixed to the frame of the conveyance unit, and that can pivot around the second shaft, with respect to the pivot unit. Note that the pivot unit may be constituted by a single member (or a plurality of members connected to each other so as not to move relative to each other).

Next, components of the hinge portion 504 will be described in detail. As illustrated in FIG. 10, the fixing member 31 includes a bottom plate (not illustrated) fixed to the reader frame 103A, a pair of side plates 31d extending upward from the bottom plate, and a back plate 31e extending upward from the bottom plate. That is, the fixing member 31 is formed like a box whose upper portion and front portion are opened, by the bottom plate, the side plates 31d, and the back plate 31e. In addition, each of the pair of side plates 31d has a through-hole 31a. The hinge pivot shaft 35 is inserted into the through-hole 31a, with the axial direction of the hinge pivot shaft 35 being equal to the right-and-left direction; and is supported by the through-hole 31a.

The torque applying portion 50 includes a spring member accommodated in the fixing member 31, and urges the lift shaft 33A while receiving a reaction force of the fixing member 31. In this manner, a pivot unit 30 that includes the lift shaft 33A, the first pivot member 32, the second pivot member 33, and the book pivot shaft 36 is urged in a direction (i.e., a counterclockwise direction in FIG. 9B) in which the ADF 102 is opened, pivoted around the hinge pivot shaft 35. The torque applying portion 50 applies torque to the pivot unit 30 in a direction in which the ADF 102 is opened, by using the urging force (elastic force) of the spring member in accordance with an open/close angle An1 of the first pivot member 32. The open/close angle An1 (FIG. 9B) is a pivot angle of the first pivot member 32 that pivots with respect to the fixing member 31, with the hinge pivot shaft 35 serving as a fulcrum. The first pivot member 32 pivots with reference to the ADF 102 that is positioned in the closed position.

As illustrated in FIG. 10, the first pivot member 32 includes a top plate 32c, and a pair of side plates that extends downward from the top plate 32c. The first pivot member 32 is U-shaped so as to cover the fixing member 31 from above. In each of the pair of side plates, a through-hole 32a is formed in an end portion on the back side, and a through-hole 32b is formed in an end portion on the front side. The hinge pivot shaft 35, which is inserted also into the through-hole 31a of the fixing member 31, is inserted into the through-hole 32a on the back side. In addition, the book pivot shaft 36 is inserted into the through-hole 32b on the front side such that the axial direction of the book pivot shaft 36 is equal to the right-and-left direction, and is supported by the through-hole 32b. Thus, the book pivot shaft 36 is disposed at a position different from the position of the hinge pivot shaft 35, and parallel to the hinge pivot shaft 35. The first pivot member 32 can pivot with respect to the fixing member 31, with a center CT1 of the hinge pivot shaft 35 serving as a fulcrum.

As illustrated in FIG. 10, the second pivot member 33 includes a top plate 33c, and a pair of side plates 33d that extends downward from the top plate 33c. In other words, the second pivot member 33 includes the side plates 33d formed like a plate and substantially orthogonal to the book pivot shaft 36, the lift shaft 33A, and the equalizing shaft 37. The second pivot member 33 includes the top plate 33c formed like a plate and substantially orthogonal to the side plates 33d. That is, the second pivot member 33 is U-shaped so as to cover the first pivot member 32 from above.

In each of the pair of side plates 33d, a through-hole 33a is formed in the vicinity of an end portion on the front side, and a through-hole 33b is formed on the front side of the through-hole 33a. The book pivot shaft 36, which is inserted also into the through-hole 32b of the first pivot member 32, is inserted into the through-hole 33a. The equalizing shaft 37 is inserted into the through-hole 33b such that the axial direction of the equalizing shaft 37 is equal to the right-and-left direction. Thus, the lift shaft 33A and the equalizing shaft 37 are disposed at positions different from the position of the book pivot shaft 36, and parallel to the book pivot shaft 36. The second pivot member 33 can pivot with respect to the first pivot member 32, with a center CT2 of the book pivot shaft 36 serving as a fulcrum.

The second pivot member 33 configured in this manner can pivot around the book pivot shaft 36 toward a direction (i.e., a clockwise direction in FIG. 9B) opposite to the direction in which the first pivot member 32 pivots around the hinge pivot shaft 35. The second pivot member 33, together with the third pivot member 34, pivots with respect to the first pivot member 32, so that the ADF 102 can take a substantially horizontal posture, regardless of the open/close angle An1, as long as the open/close angle An1 of the first pivot member 32 is within a predetermined range. For example, in a case where a thick document, such as a book, is placed on the document platen glass 301 for reading an image of the document, since the ADF 102 can take a substantially horizontal posture, the document can be pressed firmly against the document platen glass 301.

As illustrated in FIG. 10, the third pivot member 34 includes a top plate 34c, and a pair of side plates 34d that extends downward from the top plate 34c. The side plates 34d, which constitute a pair, are disposed so as to face each other. In other words, the third pivot member 34 includes the pair of side plates 34d formed like a plate and substantially orthogonal to the equalizing shaft 37, and the top plate 34c formed like a plate and substantially orthogonal to the pair of side plates 34d. That is, the third pivot member 34 is U-shaped so as to cover the second pivot member 33 from above. The top plate 34c of the third pivot member 34 is disposed above the top plate 33c of the second pivot member 33.

In each of the pair of side plates 34d, a through-hole 34a is formed in an end portion on the front side. In addition, the equalizing shaft 37 is inserted into the through-hole 34a. That is, the equalizing shaft 37 is supported by an end portion of the pivot unit 30 opposite to the hinge pivot shaft 35. The third pivot member 34 can pivot with respect to the second pivot member 33, with a center CT3 of the equalizing shaft 37 serving as a fulcrum. Note that the equalizing shaft 37 may be fixed to the side plates 34d of the third pivot member 34 by crimping the equalizing shaft 37 onto the side plates 34d. In another case, the equalizing shaft 37 may be supported by the side plates 34d of the third pivot member 34 and the side plates 33d of the second pivot member 33 so as to be able to rotate.

In addition, a supporting plate portion 34g is formed integrally with a corresponding one of the side plates 34d, by bending the side plate (metal plate) 34d. For example, the supporting plate portion 34g has screw holes 34b formed at five positions. Thus, screws are screw-fit to the ADF frame 102A through the screw holes 34b, so that the supporting plate portions 34g are fastened to the ADF frame 102A. In this manner, the third pivot member 34 and the ADF frame 102A are integrated with each other, and the third pivot member 34 moves together with the ADF 102.

In addition, as illustrated in FIG. 10, the equalizing spring 71 is attached in a state where the equalizing spring 71 is fitted around a first screw 72 fixed to the second pivot member 33. The first screw 72 is screw-fit to a screw hole 33e formed in a front end portion of the top plate 33c of the second pivot member 33. In addition, a first groove 34e is formed in the top plate 34c of the third pivot member 34 at a position corresponding to the position of the screw hole 33e. One end of the equalizing spring 71 is in contact with a head portion 72b of the first screw 72, and the other end of the equalizing spring 71 is in contact with a portion of the top plate 34c around the first groove 34e of the third pivot member 34. The equalizing spring 71 may be a compression coil spring.

The equalizing spring 71 urges the third pivot member 34 downward at a position opposite to the equalizing shaft 37 in the front-and-back direction, that is, on the back side. The effect of the equalizing spring 71 will be described below.

Note that a restricting portion 80 is disposed adjacent to the first screw 72 in the right-and-left direction. The restricting portion 80 includes a second screw 82 fixed to the second pivot member 33, a cylindrical collar 81 in which the second screw 82 is inserted, and a second groove 34f of the third pivot member 34 which engages with the collar 81. The restricting portion 80 has a function to restrict the position of the third pivot member 34 in the right-and-left direction, and a function to limit the range of pivot of the third pivot member 34 with respect to the second pivot member 33.

### Equalizing Operation

Next, an equalizing operation of the hinge portion 504 will be described with reference to FIGS. 11A to 11C. FIG. 11A is a schematic side view illustrating a state where the ADF 102 is closed without being bent. FIG. 11B is a schematic side view illustrating a state where the ADF 102 is bent and the front abutting portion abuts against the image reading unit. FIG. 11C is a schematic side view illustrating a state where the ADF 102 is bent and the front abutting portion and the back abutting portion abut against the image reading unit.

The above-described document feeding-reading operation is performed in a state where the ADF 102 is closed. In a state where the ADF 102 is closed, if both of the first abutment portion 501 and the second abutment portion 502 abut against the document feeding-reading glass 300, the posture of the ADF 102 with respect to the reading unit 103 can be kept properly.

FIG. 11A illustrates a case where the first abutment portion 501 and the second abutment portion 502, and a top surface 40S of the reading unit 103 that includes the top surface 300a of the document feeding-reading glass 300 are properly positioned with respect to each other because the ADF 102 has high stiffness. In this case, if the ADF 102 is closed, both of the first abutment portion 501 and the second abutment portion 502 naturally abut against the top surface 300a of the document feeding-reading glass 300.

However, there is a case where the reader frame 103A or the ADF frame 102A deforms due to the component tolerance in manufacturing or the change over time after the start of use. In this case, as illustrated in FIG. 11B, even if the ADF 102 is closed to a position at which one of the first abutment portion 501 and the second abutment portion 502 abuts against the top surface 300a of the document feeding-reading glass 300, the other of the first abutment portion 501 and the second abutment portion 502 may not abut against the top surface 300a of the document feeding-reading glass 300.

Specifically, there is a case where a resin frame is used recently as a frame member that constitutes the reader frame 103A and/or the ADF frame 102A, for reducing weight. In general, the resin frame has lower stiffness than that of the metal frame. Thus, if upward force Ft is constantly applied to the ADF frame 102A by the torque applied by the torque applying portion 50, the ADF frame 102A may deform due to the change over time. As illustrated in FIG. 11B, since a portion of the ADF 102 on the front side of the center of gravity bends downward due to its self weight W (hereinafter referred to as bending down in front), the second abutment portion 502 on the front side abuts against the document feeding-reading glass 300 earlier than the first abutment portion 501 does. Thus, if the ADF frame 102A is deformed over time by the force Ft caused by the torque applied by the torque applying portion 50, it becomes difficult for the first abutment portion 501 on the back side to abut against the document feeding-reading glass 300 even if the ADF 102 is closed.

In the hinge portion 504 of the present embodiment, however, the equalizing spring 71 urges the third pivot member 34 in a counterclockwise direction in FIG. 11C, around the equalizing shaft 37. The third pivot member 34 is fixed to the ADF frame 102A. In addition, the urging direction of the equalizing spring 71 (i.e., the counterclockwise direction in FIG. 11C) is a direction in which the back end of the ADF 102 is pushed down (or the front end of the ADF 102 is lifted). Thus, as illustrated in FIG. 11C, even if the bending down in front of the ADF 102 occurs due to the change over time, the first abutment portion 501 on the back side can be abutted against the document feeding-reading glass 300.

In the present embodiment, the equalizing spring 71 provides the urging force, regardless of the dimensional tolerance of components and the change over time, for keeping the parallelism of the ADF 102 with respect to the document feeding-reading glass 300 (that is, for equalizing the ADF 102) in a state where the ADF 102 is closed. That is, in a state where the ADF 102 is closed, the hinge portion 504 disposed at an end portion of the reading unit 103 on the back side (first side) applies the moment to the ADF 102, which is produced by the urging force of the equalizing spring (urging member) 71, and by which the end portion of the ADF 102 on the back side is moved downward. The equalizing spring 71 of the present embodiment urges the third pivot member (second member) 34 so that the above-described moment is produced around the equalizing shaft (second shaft) 37.

As described above, the hinge portion 504 of the present embodiment has a function that more reliably abuts both of the first abutment portion 501 and the second abutment portion 502 against the document feeding-reading glass 300 by using the urging force of the equalizing spring 71 in a state where the ADF 102 is closed.

However, in a state where the ADF 102 is closed, the urging force of the equalizing spring 71 is applied downward to the ADF 102. As a result, in the present embodiment, the total load applied downward from the first abutment portion 501 and the second abutment portion 502 to the document feeding-reading glass 300 becomes larger than that in a case where the equalizing spring 71 is not disposed.

However, the document feeding-reading glass 300 of the present embodiment is supported by the support structure that is the same as that described in the first embodiment and used for the document feeding-reading glass 300. Thus, even if the total load applied downward from the first abutment portion 501 and the second abutment portion 502 to the document feeding-reading glass 300 becomes larger due to the use of the hinge portion 504 that includes the equalizing spring 71, the bending of the document feeding-reading glass 300 can be reduced. Thus, the support structure for the document feeding-reading glass 300 of the first embodiment and the second embodiment is especially useful in the configuration in which the urging force of the urging member (i.e., the equalizing spring 71) included in the hinge portion 504 is applied downward to the ADF 102.

### Modifications

In the second embodiment, the description has been made for the equalizing spring 71, as an example of an urging member, that equalizes the ADF 102. However, the present disclosure is not limited to this. For example, the urging member may be a spring that is included in the hinge portion, and that causes the urging direction to change in accordance with the opening angle of the ADF 102. The spring reduces the load of operation caused by the weight of the ADF 102, by urging the ADF 102 toward the opening direction in a state where the opening angle of the ADF 102 is equal to or larger than a predetermined angle. In contrast, the spring positions the ADF 102 at a closed position by urging the ADF 102 toward the closing direction in a state where the opening angle of the ADF 102 is smaller than the predetermined angle.

### Other Embodiments

In the above-described embodiments, the description has been made for the image reading apparatus 101 attached to a top portion of the printer body 104, as a portion of the image forming apparatus. However, the present disclosure is not limited to this. This technology can also be applied to an image reading apparatus that can be used independently of the image forming apparatus.

The present disclosure provides an image reading apparatus and an image forming apparatus that can reduce the bending of the light-transmissive member.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-161252, filed Sep. 18, 2024, which is hereby incorporated by reference herein in its entirety.

What is claimed is:

1. An image reading apparatus comprising:
a reading unit including a frame, a transparent glass plate supported by the frame, and an image sensor configured to read image information from a sheet through the transparent glass plate; and
a conveyance unit including a plurality of conveyance rollers and configured to convey the sheet whose image information is to be read by the image sensor by using the plurality of conveyance rollers, the conveyance unit being configured to be opened and closed with respect to the reading unit,
wherein the conveyance unit includes (i) a first abutment portion disposed on a first side with respect to a center of the transparent glass plate in a sheet width direction orthogonal to a sheet conveyance direction and (ii) a second abutment portion disposed on a second side opposite to the first side with respect to the center of the transparent glass plate in the sheet width direction, and is configured such that the first abutment portion and the second abutment portion abut a first surface of the transparent glass plate in a state where the conveyance unit is closed, and
wherein the frame includes:
a first support portion disposed on the first side with respect to the first abutment portion in the sheet width direction and configured to support a second surface of the transparent glass plate opposite to the first surface;
a second support portion disposed on the second side with respect to the second abutment portion in the sheet width direction and configured to support the second surface of the transparent glass plate;
a third support portion disposed in a range from the first abutment portion to the second abutment portion in the sheet width direction and configured to support the second surface of the transparent glass plate; and
a fourth support portion disposed in the range from the first abutment portion to the second abutment portion in the sheet width direction, and on the second side with respect to the third support portion, and configured to support the second surface of the transparent glass plate.

2. The image reading apparatus according to claim 1,
wherein the frame includes a first frame member including a bottom surface portion that forms a bottom surface of the image reading apparatus, and
wherein the first support portion, the second support portion, the third support portion, and the fourth support portion are supported by the bottom surface portion.

3. The image reading apparatus according to claim 2,
wherein the frame includes a second frame member attached to the first frame member so as to cover the first frame member from above, the second frame having an opening portion in which the transparent glass plate is disposed, and
wherein each of the first frame member and the second frame member is made of resin material.

4. The image reading apparatus according to claim 3, further comprising:
a reinforcement member attached to the second frame member and configured to reinforce the transparent glass plate.

5. The image reading apparatus according to claim 4,
wherein the reinforcement member extends over a range that at least includes a reading area in the sheet width direction, the reading area being a range in which the image sensor reads image information, and
wherein at least a portion of an edge portion of the transparent glass plate that extends in the sheet width direction is sandwiched between the second frame member and the reinforcement member in a thickness direction of the transparent glass plate.

6. The image reading apparatus according to claim 2,
wherein at least one of the first support portion, the second support portion, the third support portion, and the fourth support portion is formed integrally with the first frame member.

7. The image reading apparatus according to claim 2,
wherein at least one of the first support portion, the second support portion, the third support portion, and the fourth support portion is a member separate from the first frame member, and is fixed to the first frame member.

8. The image reading apparatus according to claim 1,
wherein the first support portion and the second support portion are disposed outside a reading area in the sheet width direction and at positions that overlap with the reading area in the sheet conveyance direction, the reading area being a range in which the image sensor reads image information, and
wherein the third support portion and the fourth support portion are disposed inside the reading area in the sheet width direction, and outside the reading area in the sheet conveyance direction.

9. The image reading apparatus according to claim 8,
wherein the third support portion is disposed in an area on the first side, of areas obtained by trisecting the range from the first abutment portion to the second abutment portion in the sheet width direction, and
wherein the fourth support portion is disposed in an area on the second side, of the areas obtained by trisecting the range from the first abutment portion to the second abutment portion in the sheet width direction.

10. The image reading apparatus according to claim 1,
wherein the third support portion is disposed on the second side with respect to the first abutment portion in the sheet width direction, and
wherein the fourth support portion is disposed on the first side with respect to the second abutment portion in the sheet width direction.

11. The image reading apparatus according to claim 1,
wherein the frame further includes a fifth support portion disposed between the third support portion and the fourth support portion in the sheet width direction and configured to support the second surface of the transparent glass plate.

12. The image reading apparatus according to claim 11,
wherein the fifth support portion is disposed in a center area of areas obtained by trisecting a range from the first abutment portion to the second abutment portion in the sheet width direction.

13. The image reading apparatus according to claim 11, further comprising:
a guide member extending in a direction that intersects the sheet width direction, and configured to guide movement of the image sensor; and
a fixing portion configured to fix the guide member to the frame,
wherein the fifth support portion is formed integrally with the fixing portion.

14. The image reading apparatus according to claim 1, further comprising:
a sensor configured to detect a position of the image sensor in a direction that intersects the sheet width direction; and
a holding portion configured to hold the sensor,
wherein at least one of the first support portion, the second support portion, the third support portion, and the fourth support portion is formed integrally with the holding portion.

15. The image reading apparatus according to claim 1, further comprising:
a hinge portion configured to pivotally connect the reading unit and the conveyance unit,
wherein the hinge portion includes an urging member configured to apply downward force to the conveyance unit in a state where the conveyance unit is closed.

16. The image reading apparatus according to claim 15,
wherein the hinge portion is disposed at an end portion of the reading unit on the first side in the sheet width direction and configured to apply moment to the conveyance unit in a state where the conveyance unit is closed, such that the moment is produced by urging force of the urging member and the end portion of the conveyance unit on the first side is urged downward by the moment.

17. The image reading apparatus according to claim 16,
wherein the hinge portion includes
a first member fixed to the frame of the reading unit,
a first shaft supported by the first member,
a pivot unit configured to pivot with respect to the first member around the first shaft,
a second shaft supported by the pivot unit, and
a second member fixed to a frame of the conveyance unit and configured to pivot with respect to the pivot unit, around the second shaft, and
wherein the urging member is configured to urge the second member in a state where the conveyance unit is closed, such that the moment is produced around the second shaft.

18. An image forming apparatus comprising:
an image forming apparatus body; and
an image reading apparatus,
wherein the image forming apparatus body includes an image forming portion configured to perform an image forming operation that forms an image on a recording material, based on image information that is read by the image reading apparatus,
wherein the image reading apparatus includes:
a reading unit including a frame, a transparent glass plate supported by the frame, and an image sensor configured to read image information from a sheet through the transparent glass plate; and
a conveyance unit including a plurality of conveyance rollers and configured to convey the sheet whose image information is to be read by the image sensor by using the plurality of conveyance rollers, the conveyance unit being configured to be opened and closed with respect to the reading unit,
wherein the conveyance unit includes (i) a first abutment portion disposed on a first side with respect to a center of the transparent glass plate in a sheet width direction orthogonal to a sheet conveyance direction and (ii) a second abutment portion disposed on a second side opposite to the first side with respect to the center of the transparent glass plate in the sheet width direction, and is configured such that the first abutment portion and the second abutment portion abut a first surface of the transparent glass plate in a state where the conveyance unit is closed, and
wherein the frame includes:
a first support portion disposed on the first side with respect to the first abutment portion in the sheet width direction and configured to support a second surface of the transparent glass plate opposite to the first surface;
a second support portion disposed on the second side with respect to the second abutment portion in the sheet width direction and configured to support the second surface of the transparent glass plate;
a third support portion disposed in a range from the first abutment portion to the second abutment portion in the sheet width direction and configured to support the second surface of the transparent glass plate; and
a fourth support portion disposed in the range from the first abutment portion to the second abutment portion in the sheet width direction, and on the second side with respect to the third support portion, and configured to support the second surface of the transparent glass plate.
